(19) United States
(12) Patent Application Publication
(10) Pub. No.: US 2008/0095922 A1
(43) Pub. Date: Apr. 24, 2008

(54) METHOD OF MANUFACTURING GAS SENSOR USING METAL LIGAND AND CARBON NANOTUBES

(75) Inventors: Sung-ouk JUNG, Yongin-si (KR); Soo-suk LEE, Yongin-si (KR); In-ho LEE, Yongin-si (KR); Hun-joo LEE, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/750,449

(22) Filed: May 18, 2007

(30) Foreign Application Priority Data
Jul. 31, 2006 (KR) 10-2006-0072262

(51) Int. Cl. B05D 3/02; B05D 3/00

(52) U.S. Cl. 427/58; 977/742

(57) ABSTRACT

A method of manufacturing a gas sensor includes using a metal ligand and carbon nanotubes (“CNTs”). The method includes forming electrodes on a substrate, coating a paste, in which the metal ligand including a metal having adsorption selectivity with respect to at least one specific gas and carbon nanotubes (“CNTs”) are mixed, on the substrate on which the electrodes are formed, and reducing the metal ligand in the paste.

This application claims priority to Korean Patent Application No. 10-2006-0072262, filed on Jul. 31, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a method of manufacturing a gas sensor, and more particularly, to a method of manufacturing a gas sensor using carbon nanotubes.

2. Description of the Related Art

While scientific developments have improved the quality of human life, the extensive and rapid destruction of nature caused by the industrialization process and environmental contamination due to increased energy consumption poses a great threat to people.

Accordingly, reliable and highly sensitive gas sensors that can detect and quantify various harmful gases that cause air contamination are needed. Presently, gas sensors are widely used in various fields such as industry (manufacturing, agricultural, livestock, office equipment, catering, ventilation), crime prevention (alcohol level check), environment (air contamination surveillance, combustion control), disaster prevention (gas leaking, oxygen deficient alarm in mines, fire surveillance), medical (gas analysis in blood, anesthesia gas analysis), etc., and applications for gas sensors are widening every day.

In general, a gas sensor measures the amount of a harmful gas by change of electrical conductivity or electrical resistance according to the degree of adsorption of gas molecules. In the prior art, the gas sensor was manufactured using a metal oxide semiconductor (“MOS”), a solid electrolyte material, or other organic materials. However, a gas sensor that uses the MOS or the solid electrolyte material performs a sensing operation when the gas sensor is heated to 200-600° C. or more. A gas sensor that uses an organic material has a very low electrical conductivity, and a gas sensor that uses carbon black and an organic complex has a very low sensitivity.

Carbon nanotubes (“CNTs”) that have recently drawn attention as a new material can be applied to various industrial fields due to its high electron emission characteristics and high chemical reactivity. In particular, the CNT is a material that has a very wide surface area compared to its volume. Therefore, the CNT is very useful for application to fields such as detection of a minor chemical component and hydrogen storage. A gas sensor that uses CNTs detects a harmful gas by measuring an electrical signal (conductance, resistance) that is changed according to the electron property of a gas adsorbed to the CNTs. When the CNTs are used in a gas sensor, there are advantages in that a sensing operation can start at room temperature, and sensitivity and the speed of response are very high since there is a high electrical conductivity when a harmful gas such as NH₃ or NO₂ reacts with the CNTs. However, a gas sensor that uses only CNTs has a disadvantage in that there is a lack of selectivity with respect to a specific gas.

As a method of supplementing the disadvantage of the gas sensor that uses CNTs, a metal that has an adsorption selectivity with respect to a specific gas is deposited on CNTs using a sputtering method or a chemical vapor deposition (“CVD”) method. However, this method requires expensive equipment such as a sputtering apparatus or a CVD apparatus, and the manufacturing process of the gas sensor is also very complicated.

### BRIEF SUMMARY OF THE INVENTION

The present invention provides a gas sensor that can be manufactured by a simple process using a metal ligand and CNTs.

According to exemplary embodiments of the present invention, there is provided a method of manufacturing a gas sensor, the method including forming electrodes on a substrate, coating a paste, in which a metal ligand including a metal that has adsorption selectivity with respect to a specific gas and carbon nanotubes (“CNTs”) are mixed, on the substrate on which the electrodes are formed, and reducing the metal ligand in the paste.

The metal ligand may be reduced using heat and a reducing agent, such as by baking the paste under a under an H₂ and N₂ atmosphere.

The paste may be coated to cover the electrodes formed on the substrate, and coating the paste may be performed by coating a mixed solution on the substrate on which the electrodes are formed after the mixed solution is formed by uniformly distributing the CNTs and the metal ligand in a predetermined solvent.

Forming electrodes on the substrate may include depositing a metal material on the substrate and patterning the metal material. The electrodes may include first and second electrodes formed in an inter-digitated shape, wherein the first electrode includes a first extension portion and first finger portions extending from the first extension portion, and the second electrode includes a second extension portion and second finger portions extending from the second extension portion, and the first finger portions are alternately arranged with the second finger portions.

According to exemplary embodiments of the present invention, there is provided a method of manufacturing a gas sensor, the method including mixing a metal ligand and carbon nanotubes in a solvent to form a paste, coating the paste on electrodes, and reducing the metal ligand in the paste such that a metal having adsorption selectivity with respect to a specific gas remains in the paste.

Mixing the metal ligand and carbon nanotubes in the solvent may include uniformly distributing the metal ligand and the carbon nanotubes in the solvent and may include using sonication.

Coating the paste on electrodes may include coating the paste on alternately arranged and spaced finger portions of first and second electrodes.

Reducing the metal ligand in the paste may include using heat, such as baking at a temperature of approximately 250° C. Reducing the metal ligand in the paste may further include using a reducing agent and reducing the metal ligand in the paste may include baking under an H₂ and N₂ atmosphere.

The method may further include forming the electrodes on a substrate, such that coating the paste on the electrodes further includes coating the paste on at least portions of the substrate exposed by the electrodes.

### BRIEF DESCRIPTION OF THE DRAWINGS

The above and other features and advantages of the present invention will become more apparent by describing in detail exemplary embodiments thereof with reference to the attached drawings in which:

FIG. 1A is a plan view illustrating exemplary electrodes formed on an exemplary substrate, and FIG. 1B is a cross-sectional view taken along line I-I′ of FIG. 1A;

FIG. 2A is a plan view illustrating an exemplary paste coated on the exemplary electrodes and substrate, and FIG. 2B is a cross-sectional view taken along line II-II′ of FIG. 2A;

FIG. 3A is a plan view illustrating an altered state of the exemplary paste on the exemplary electrodes and substrate, and FIG. 3B is a cross-sectional view taken along line III-III′ of FIG. 3A;

FIGS. 4 through 6 are scanning electron microscope (“SEM”) images of CNTs, palladium Pd, and a complex of CNTs and palladium Pd, respectively; and

FIG. 7 is a graph showing the comparison of conductance variation according to the concentration of methane in a conventional gas sensor using only CNTs, and an exemplary gas sensor using a complex of CNTs and palladium Pd, according to an exemplary embodiment of the preset invention.

### DETAILED DESCRIPTION OF THE INVENTION

The present invention will now be described more fully with reference to the accompanying drawings in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like reference numerals in the drawings denote like elements and the thicknesses of layers and regions are exaggerated for clarity.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described in detail with reference to the accompanying drawings.

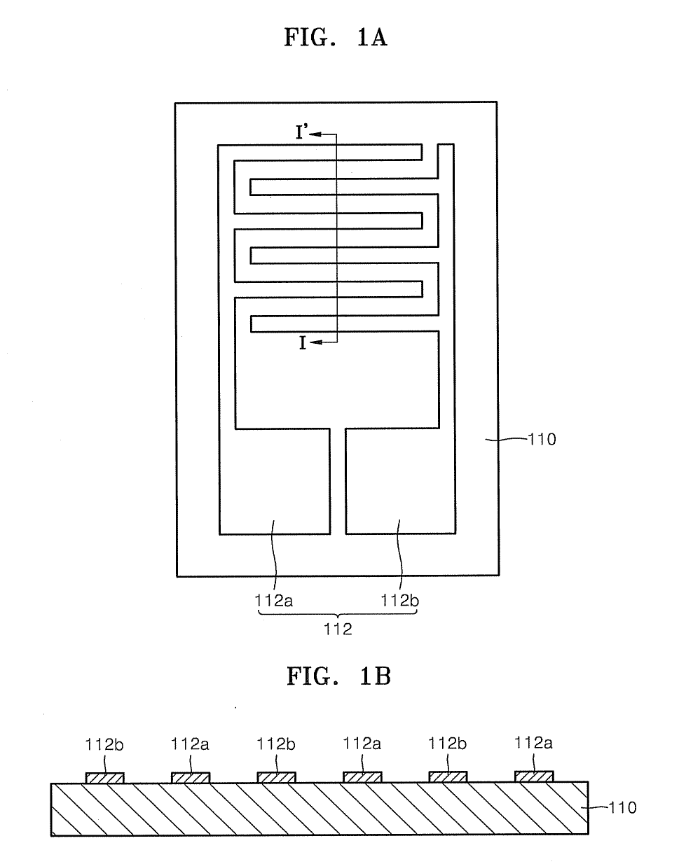

FIGS. 1A through 3B are drawings for describing an exemplary method of manufacturing an exemplary gas sensor according to an exemplary embodiment of the present invention.

FIG. 1A is a plan view illustrating exemplary electrodes formed on an exemplary substrate 110 and FIG. 1B is a cross-sectional view taken along line I-I′ of FIG. 1A.

Referring to FIGS. 1A and 1B, electrodes 112 that include a first electrode 112a and a second electrode 112b are formed on the substrate 110. The first and second electrodes 112a and 112b can be formed in, for example, an inter-digitated shape, but the first and second electrodes 112a and 112b are not limited thereto and can be formed in various other shapes. For the inter-digitated shape, each of the first and second electrodes 112a and 112b may include a main body portion, an extension portion extending from the main body portion, and a plurality of finger portions extending angularly, such as perpendicularly, from the extension portion. The main body portion and extension portion of the first electrode 112a may be disposed on a first side of the substrate 110 and the main body portion and extension portion of the second electrode 112b may be disposed on a second side of the substrate 110, where the second side is opposite the first side. The finger portions of the first electrode 112a may extend from the extension portion on the first side towards the second side and the finger portions of the second electrode 112b may extend from the extension portion on the second side towards the first side. The finger portions of the first electrode 112a are disposed alternately with the finger portions of the second electrode 112b with a gap formed between the finger portions of the first electrode 112a and the finger portions of the second electrode 112b. The first and second electrodes 112a and 112b can be formed by patterning a metal material having a high electrical conductivity after the material is deposited on the substrate 110. For example, the first and second electrodes 112a and 112b can be formed of gold Au or titanium Ti, but the present invention is not limited thereto.

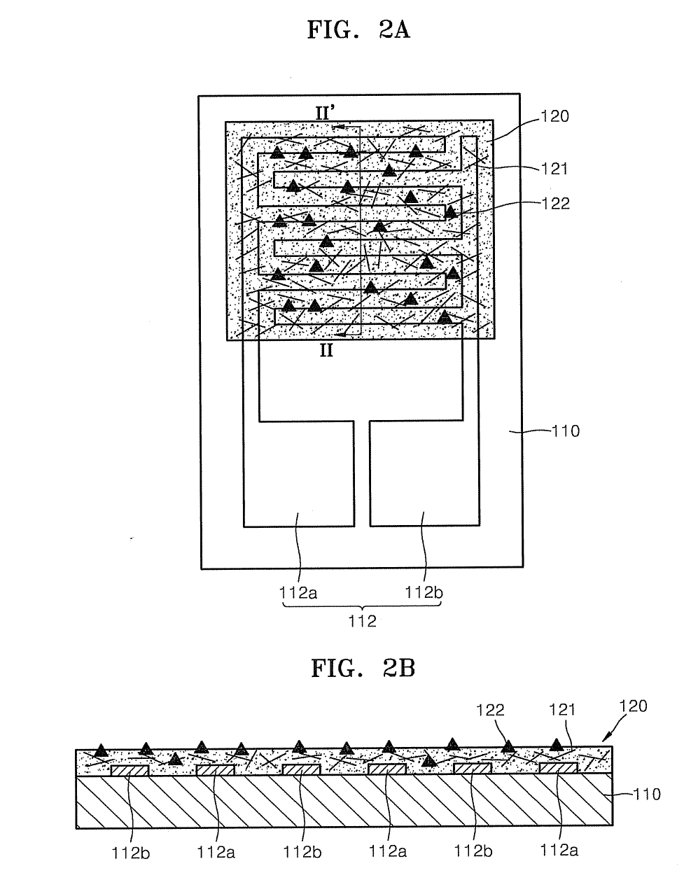

FIG. 2A is a plan view illustrating an exemplary paste 120, in which a metal ligand 122 and carbon nanotubes (“CNTs”) 121 are mixed, coated on the substrate 110 on which the electrodes 112 are formed, and FIG. 2B is a cross-sectional view taken along line II-II′ of FIG. 2A.

Referring to FIGS. 2A and 2B, the paste 120 in which the metal ligand 122 and CNTs 121 are mixed is prepared. The metal ligand 122 includes a metallic element as a central atom with an atom or molecule attached to the central atom in a coordination or complex compound. The paste 120 can be manufactured by uniformly distributing the metal ligand 122 and the CNTs 121 in a predetermined solvent.

In the present embodiment, the metal ligand 122 includes a metal that has adsorption selectivity with respect to a specific gas. In general, there are gases that can be adsorbed by a specific metal. For example, a gas consisting of dichloroethylene, acetic acid, or propanoic acid can be adsorbed to silver Ag, and a gas consisting of ethylene, benzene, or cyclohexane can be adsorbed to iridium Ir. Also, a gas consisting of methane or formic acid can be adsorbed to molybdenum Mo, and a gas consisting of methane, methanol, or benzene can be adsorbed to nickel Ni. A gas consisting of benzene, acetylene, ethylene, methanol, benzene+CO, or methane can be adsorbed to palladium Pd, and a gas consisting of aniline, ammonia, cyanobenzene, m-xylene, naphthalene, N-butylbenzene, or acetonitrile can be adsorbed to platinum Pt. Besides the above examples, there are various other metals that have adsorption selectivity with respect to other specific gases. In the present embodiment, a gas sensor is manufactured using the characteristics of metals that selectively adsorb specific gases, such that a gas sensor may be designed for specific gases. That is, a metal that has adsorption selectivity with respect to specific gases as described above is included in the metal ligand 122 that is mixed with the CNTs 121.

Next, the paste 120 in which the metal ligand 122 and CNTs 121 are mixed is coated on the substrate 110 on which the electrodes 112 are formed. Here, the paste 120 can be coated to cover the electrodes 112. The paste 120 may cover the finger portions of the electrodes 112a and 112b, or may cover additional portions thereof.

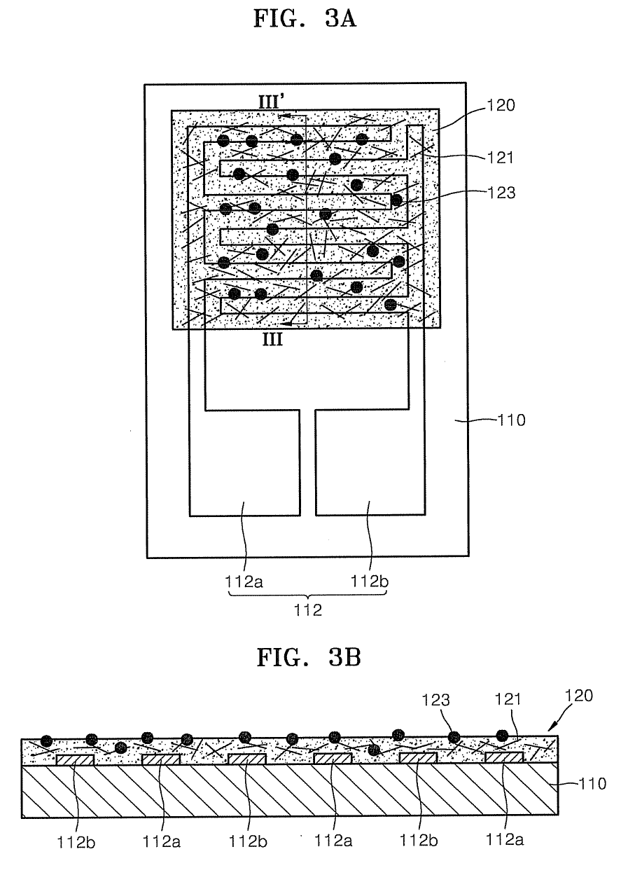

FIG. 3A is a plan view illustrating a reduced state of the exemplary metal ligand 122 in the exemplary paste 120, and FIG. 3B is a cross-sectional view taken along line III-III′ of FIG. 3A.

Referring to FIGS. 3A and 3B, the manufacture of a gas sensor according to an exemplary embodiment of the present invention includes reducing the metal ligand 122 present in the paste 120 coated on the substrate 110 on which the electrodes 112 are formed to form a metal 123 in the paste 120 on the substrate 110. The reduction of the metal ligand 122 can be performed using heat and a reducing agent. More specifically, the metal ligand 122 can be reduced by baking at a predetermined temperature under a H₂ and N₂ atmosphere. When the metal ligand 122 is reduced, a complex, in which there is the metal 123 that has adsorption selectivity with respect to specific gases and the CNTs 121, is present in the paste 120.

<Experiment 1: Gas Sensor Manufacturing>

PdCl₂ 0.005 g/50 ml was used as a metal ligand that includes a metal having adsorption selectivity with respect to specific gases, and single-walled nanotubes (“SWNTs”) (single-walled CNTs) 0.05 g/50 mg were used. The PdCl₂ and the SWNTs are mixed in an N,N-dimethylformamide (“DMF”) solvent in a mixing ratio of 1:1 using sonication. The manufactured paste was coated on a substrate on which electrodes are formed using a spray coating method. Next, the paste in which the PdCl₂ and CNTs were mixed was baked at a temperature of approximately 250° C. for four hours under an H₂ and N₂ atmosphere. As a result, a complex of Pd reduced from PdCl₂ and CNTs was formed in the paste.

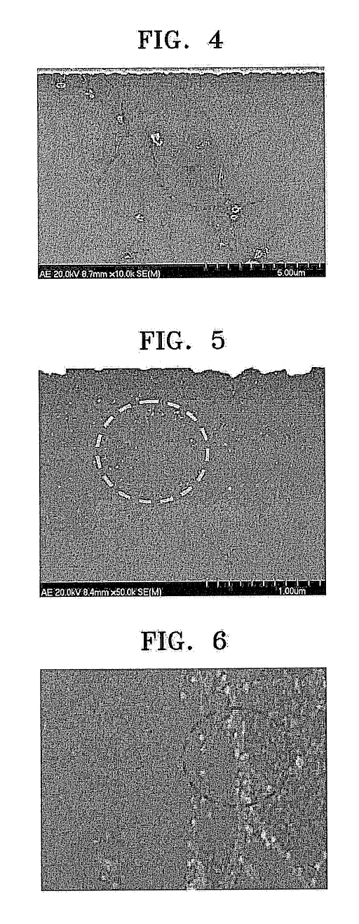

FIG. 4 is a scanning electron microscope (“SEM”) image of SWNTs, FIG. 5 is an SEM image of palladium Pd, and FIG. 6 is an SEM image of a complex of palladium Pd and CNTs manufactured in experiment 1. Referring to FIG. 6, it is seen that palladium Pd is gathered around the CNTs.

<Experiment 2: Gas Measurement>

The conductance variations, ΔG=[G(methane)−G(air)]/G(air), according to a change in concentration of methane gas that selectively reacts with palladium Pd, were measured using a gas sensor that includes a complex of CNTs and palladium Pd, as manufactured in experiment 1, and a conventional gas sensor that only includes CNTs. The concentrations of methane gas used were 25 ppm, 125 ppm, and 250 ppm, and the conductance variations ΔG were measured at room temperature.

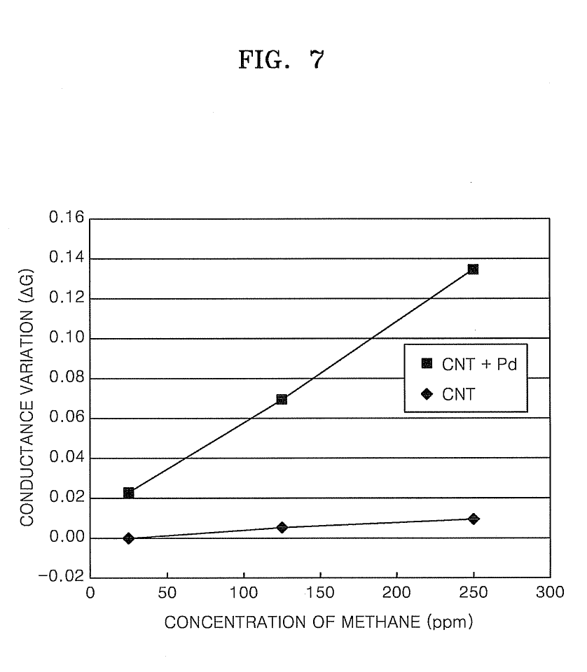

The measurements are shown in FIG. 7. FIG. 7 is a graph showing the comparison of conductance variations according to a change in concentration of methane in a conventional gas sensor that uses only CNTs and an exemplary gas sensor that uses a complex of CNTs and Pd, as manufactured in experiment 1, according to an embodiment of the preset invention. Referring to FIG. 7, as the concentration of methane gas increases to 25 ppm, 125 ppm, and 250 ppm, the conductance variations ΔG of CNTs in the conventional gas sensor were 0.00, 0.01, and 0.01, respectively, and the conductance variations ΔG of the complex of Pd and CNTs in the exemplary gas sensor of the exemplary embodiment respectively were 0.02, 0.07, and 0.13, respectively. That is, the CNTs in the conventional gas sensor have little conductance variation according to the increase in the concentration of methane gas. However, the complex of Pd and CNTs in the exemplary gas sensor according to the present embodiment shows a large conductance variation according to the increase in the concentration of methane gas. From the result of the experiment, it is seen that the gas sensor that uses only CNTs does not have selectivity with respect to methane gas, but the gas sensor that uses a complex of Pd and CNTs has selectivity with respect to methane gas.

While experiments 1 and 2 have been described with respect to an exemplary gas sensor made with a complex of palladium Pd and CNTs, it should be understood that a gas sensor made by reducing a metal ligand containing an alternative metal, other than palladium Pd, having an adsorption selectivity with respect to a specific gas would also be within the scope of these embodiments.

As described above, according to the present invention, a gas sensor that includes a complex of a metal and CNTs can be manufactured by coating a paste, in which a metal ligand and CNTs are mixed, on a substrate and reducing the metal ligand. Accordingly, a gas sensor can be manufactured by a simple process as compared to a conventional process in which a metal is deposited on the CNTs using a sputtering method or a CVD method. The gas sensor manufactured according to the present invention includes not only CNTs but also a metal that has adsorption selectivity with respect to specific gases. Therefore, the gas sensor can have selectivity with respect to specific gases unlike the conventional gas sensor in which only CNTs are used. The gas sensor according to the present invention can sense various gases by changing a metal mixed with CNTs in the gas sensor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a gas sensor, the method comprising:
forming electrodes on a substrate;
coating a paste, in which a metal ligand including a metal that has adsorption selectivity with respect to at least one specific gas and, carbon nanotubes are mixed, on the substrate on which the electrodes are formed; and
reducing the metal ligand in the paste.

2. The method of claim 1, wherein reducing the metal ligand includes using heat and a reducing agent.

3. The method of claim 2, wherein reducing the metal ligand includes baking the paste under a H₂ and N₂ atmosphere.

4. The method of claim 2, wherein using heat includes baking at a temperature of approximately 250° C.

5. The method of claim 4, wherein baking includes baking for approximately four hours.

6. The method of claim 1, wherein coating the paste on the substrate includes covering the electrodes formed on the substrate.

7. The method of claim 1, wherein coating the paste includes coating a mixed solution, formed by uniformly distributing the carbon nanotubes and the metal ligand in a predetermined solvent, on the substrate on which the electrodes are formed.

8. The method of claim 1, wherein the electrodes comprise first and second electrodes formed in an inter-digitated shape.

9. The method of claim 8, wherein the first electrode includes a first extension portion and first finger portions extending from the first extension portion, and the second electrode includes a second extension portion and second finger portions extending from the second extension portion, and the first finger portions are alternately arranged with the second finger portions.

10. The method of claim 1, wherein forming electrodes on the substrate includes depositing a metal material on the substrate and patterning the metal material.

11. A method of manufacturing a gas sensor, the method comprising:
mixing a metal ligand and carbon nanotubes in a solvent to form a paste;
coating the paste on electrodes; and,
reducing the metal ligand in the paste such that a metal having adsorption selectivity with respect to a specific gas remains in the paste.

12. The method of claim 11, wherein mixing the metal ligand and carbon nanotubes in the solvent includes uniformly distributing the metal ligand and the carbon nanotubes in the solvent.

13. The method of claim 11, wherein coating the paste on electrodes includes coating the paste on alternately arranged and spaced finger portions of first and second electrodes.

14. The method of claim 11, wherein reducing the metal ligand in the paste includes using heat.

15. The method of claim 14, wherein using heat includes baking at a temperature of approximately 250° C.

16. The method of claim 14, wherein reducing the metal ligand in the paste further includes using a reducing agent.

17. The method of claim 16, wherein reducing the metal ligand in the paste includes baking under an H₂ and N₂ atmosphere.

18. The method of claim 11, wherein reducing the metal ligand in the paste includes using a reducing agent.

19. The method of claim 11, wherein mixing the metal ligand and carbon nanotubes in the solvent includes using sonication.

20. The method of claim 11, further comprising forming the electrodes on a substrate, and wherein coating the paste on the electrodes further includes coating the paste on at least portions of the substrate exposed by the electrodes.
